(19) United States
(12) Patent Application Publication
(10) Pub. No.: US 2025/0330751 A1
(43) Pub. Date: Oct. 23, 2025

(54) MOBILITY CONTROL APPARATUS AND METHOD THEREOF

(71) Applicants: HYUNDAI MOTOR COMPANY, Seoul (KR); Kia Corporation, Seoul (KR)

(72) Inventors: Sung Beom AN, Hwaseong-si (KR); Tae Ho LEE, Hwaseong-si (KR); Seung Hyun KIM, Seoul (KR)

(21) Appl. No.: 18/936,004

(22) Filed: Nov. 4, 2024

(30) Foreign Application Priority Data
Apr. 19, 2024 (KR) 10-2024-0052915

(51) Int. Cl. H04R 5/04; H04R 5/02

(52) U.S. Cl. CPC H04R 5/04; H04R 5/023; H04R 2205/024; H04R 2420/01; H04R 2499/13

(57) ABSTRACT

A mobility control apparatus and a method thereof are provided. The mobility control apparatus includes a main speaker, a sub-speaker, and a processor. The processor identifies whether at least one of media content or an application for playing the media content, or any combination thereof is being executed, receives a request signal for requesting an output of a sound via at least one of the main speaker or the sub-speaker, or any combination thereof, identifies at least one speaker to output a target sound between the main speaker and the sub-speaker, based on at least one of a priority of the sound associated with the request signal, a sound which is being output from the main speaker, or a sound which is being output from the sub-speaker, or any combination thereof, and outputs the target sound, via the identified at least one speaker.

### CROSS-REFERENCE TO RELATED APPLICATION

This application claims the benefit of priority to Korean Patent Application No. 10-2024-0052915, filed in the Korean Intellectual Property Office on Apr. 19, 2024, the entire contents of which are incorporated herein by reference.

### TECHNICAL FIELD

The present disclosure relates to a mobility control apparatus and a method thereof, and more particularly, to technologies for outputting a sound via a speaker.

### BACKGROUND

Recently, research on various forms of mobility, including vehicles, has been on the rise. As these studies have expanded, there has been a growing focus on enhancing the convenience for users who utilize or travel in these forms of mobility.

In particular, for mobility solutions capable of autonomous driving or driver assistance, various studies aimed at enhancing the user experience are ongoing. To improve the user experience, one area of research focuses on determining which speaker within the mobility should output sound while the user receives media content.

### SUMMARY

The present disclosure is directed to a mobility control apparatus for controlling a speaker included in a mobility and a method thereof.

The present disclosure is also directed to a mobility control apparatus for outputting a sound using at least one of speakers included in a mobility depending on a situation and a method thereof.

The present disclosure is also directed to a mobility control apparatus for determining a speaker to output a sound depending on a priority of the sound and a method thereof.

According to an aspect of the present disclosure, a mobility control apparatus may include a main speaker, a sub-speaker that outputs a sound independently of the main speaker, and a processor. The processor may identify whether at least one of media content or an application for playing the media content, or any combination thereof is being executed, may receive a request signal for requesting an output of a sound via at least one of the main speaker or the sub-speaker, or any combination thereof, may identify at least one speaker to output a target sound between the main speaker and the sub-speaker, based on at least one of a priority of the sound associated with the request signal, a sound which is being output from the main speaker, or a sound which is being output from the sub-speaker, or any combination thereof, and may output the target sound, via the identified at least one speaker.

In some implementations, the processor may identify a speaker to output the target sound, based on execution of the application, and may output a screen provided by the application, together with outputting the target sound using the sub-speaker, based on identifying outputting the target sound using the sub-speaker between the main speaker and the sub-speaker.

In some implementations, the processor may identify a speaker to output the target sound, based on execution of the application, and may identify a display coupled with the main speaker, based on identifying outputting the target sound using the main speaker between the main speaker and the sub-speaker.

In some implementations, based on that the display coupled with the main speaker is identified as a second display different from a first display which is outputting a screen provided by the application or that it is requested to output the target sound with a highest priority compared to sounds which are being output, the processor may provide target media content by means of the application, may fail to request the main speaker to be associated with a display different from the second display, and may provide guidance indicating that the main speaker and the second display are coupled with each other, via at least one of the first display or the second display.

In some implementations, based on that the main speaker and a second display are associated with each other or that target media content is not output via the second display, in a state in which it is requested to output the target sound with a highest priority compared to sounds which are being output, the processor may provide the target media content by means of the application, may request the main speaker to be associated with a display different from the second display, and may output the target sound, in response to that an output of the target media content is ended.

In some implementations, based on that identifying that the main speaker and a second display are coupled with each other, in a state in which it is requested to output the target sound with a highest priority compared to sounds which are being output, the processor may provide target media content by means of the application, may request the main speaker to be associated with a display different from the second display, and may output the target sound via the main speaker.

In some implementations, the processor may receive a setting signal for being set to a mode for outputting the target sound using at least one of the main speaker or the sub-speaker, or any combination thereof, in the state in which the at least one of the media content or the application for playing the media content, or the any combination thereof is being executed, may identify whether the target sound is being output via a speaker corresponding to the setting signal, and may bypass the setting signal, based on that the target sound is being output via the speaker corresponding to the setting signal. The mode may include a state set to output the target sound via selected at least one speaker, based on selecting the at least one speaker to output the target sound in a mobility.

In some implementations, the processor may change to the mode for outputting the target sound via the speaker corresponding to the setting signal, based on that the target sound is being output via a speaker different from the speaker corresponding to the setting signal.

In some implementations, the processor may output the target sound via a speaker different from the speaker corresponding to the setting signal, based on that identifying that it is impossible to output the target sound via the speaker corresponding to the setting signal.

The mobility control apparatus may further include a main display coupled with the main speaker and a sub-display coupled with the sub-speaker. The processor may guide a user to output the target sound via at least one of the main speaker or the sub-speaker, or any combination thereof, based on at least one of the main display or the sub-display, or any combination thereof.

According to another aspect of the present disclosure, a mobility control method may include identifying, by a processor, whether at least one of media content or an application for playing the media content, or any combination thereof is being executed, receiving, by the processor, a request signal for requesting an output of a sound via at least one of a main speaker or a sub-speaker, or any combination thereof, identifying, by the processor, at least one speaker to output a target sound between the main speaker and the sub-speaker, based on at least one of a priority of the sound associated with the request signal, a sound which is being output from the main speaker, or a sound which is being output from the sub-speaker, or any combination thereof, and outputting, by the processor, the target sound, via the identified at least one speaker.

The mobility control method may further include identifying a speaker to output the target sound, based on execution of the application, and outputting a screen provided by the application, together with outputting the target sound using the sub-speaker, based on identifying outputting the target sound using the sub-speaker between the main speaker and the sub-speaker.

The mobility control method may further include identifying a speaker to output the target sound, based on execution of the application, and identifying a display coupled with the main speaker, based on identifying outputting the target sound using the main speaker between the main speaker and the sub-speaker.

The mobility control method may further include, based on that the display coupled with the main speaker is identified as a second display different from a first display which is outputting a screen provided by the application or that it is requested to output the target sound with a highest priority compared to sounds which are being output, providing target media content by means of the application, failing to request the main speaker to be associated with a display different from the second display, and providing guidance indicating that the main speaker and the second display are coupled with each other, via at least one of the first display or the second display.

The mobility control method may further include, based on that the main speaker and a second display are associated with each other or that target media content is not output via the second display, in a state in which it is requested to output the target sound with a highest priority compared to sounds which are being output, providing the target media content by means of the application, requesting the main speaker to be associated with a display different from the second display, and outputting the target sound, in response to that an output of the target media content is ended.

The mobility control method may further include, based on that identifying that the main speaker and a second display are coupled with each other, in a state in which it is requested to output the target sound with a highest priority compared to sounds which are being output, providing target media content by means of the application; requesting the main speaker to be associated with a display different from the second display; and outputting the target sound via the main speaker.

The mobility control method may further include receiving a setting signal for being set to a mode for outputting the target sound using at least one of the main speaker or the sub-speaker, or any combination thereof, in the state in which the at least one of the media content or the application for playing the media content, or the any combination thereof is being executed, identifying whether the target sound is being output via a speaker corresponding to the setting signal, and bypassing the setting signal, based on that the target sound is being output via the speaker corresponding to the setting signal. The mode may include a state set to output the target sound via selected at least one speaker, based on selecting the at least one speaker to output the target sound in a mobility.

The mobility control method may further include changing to the mode for outputting the target sound via the speaker corresponding to the setting signal, based on that the target sound is being output via a speaker different from the speaker corresponding to the setting signal.

The mobility control method may further include outputting the target sound via a speaker different from the speaker corresponding to the setting signal, based on that identifying that it is impossible to output the target sound via the speaker corresponding to the setting signal.

The mobility control method may further include guiding a user to output the target sound via at least one of the main speaker or the sub-speaker, or any combination thereof, based on at least one of a main display or a sub-display, or any combination thereof.

### BRIEF DESCRIPTION OF THE DRAWINGS

FIG. 1 is a diagram illustrating an example of a mobility control apparatus.

FIG. 2 is a diagram illustrating an example of a mobility control apparatus.

FIG. 3 is a diagram illustrating an example of a mobility control method.

FIG. 4 is a diagram illustrating an example of a mobility control method.

FIG. 5 is a diagram illustrating an example of a mobility control method.

FIG. 6 is a diagram illustrating an example of a mobility control method.

FIG. 7 is a diagram illustrating an example of a mobility control method.

FIG. 8 is a diagram illustrating an example of a computing system associated with a mobility control apparatus or a mobility control method.

### DETAILED DESCRIPTION

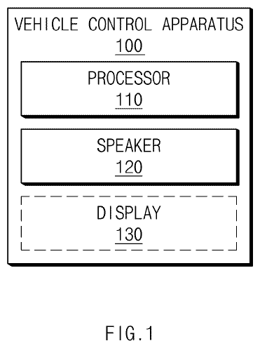

FIG. 1 illustrates an example of a block diagram associated with a mobility control apparatus.

Referring to FIG. 1, a mobility control apparatus 100 may be implemented inside or outside a mobility, and some of components included in the mobility control apparatus 100 may be implemented inside or outside the mobility. In this case, the mobility control apparatus 100 may be integrally configured with control units in the mobility or may be implemented as a separate device to be coupled with the control units of the mobility by a separate connection means. For example, the mobility control apparatus 100 may further include components.

For example, the mobility may include transportation including a vehicle, which provides mobility of a person and a thing, and a mobile service.

In some implementations, the mobility control apparatus 100 may include a processor 110 and a speaker 120. In some implementations, the mobility control apparatus 100 may further include a display 130. The processor 110, the speaker 120, and the display 130 may be electronically or operably coupled with each other by an electronical component including a communication bus.

Hereinafter, that pieces of hardware are operably coupled with each other may include that a direct connection or an indirect connection between the pieces of hardware is established in a wired or wireless manner, such that second hardware is controlled by first hardware among the pieces of hardware.

The different blocks are illustrated, but an implementation is not limited thereto. Some of the pieces of hardware of FIG. 1 may be included in a single integrated circuit including a system on a chip (SoC). Types of the pieces of hardware included in the mobility control apparatus 100 and/or the number of the pieces of hardware are/is not limited to those shown in FIG. 1. For example, the mobility control apparatus 100 may include only some of the pieces of hardware shown in FIG. 1.

The mobility control apparatus 100 may include hardware for processing data, based on one or more instructions. For example, the hardware for processing the data may include the processor 110.

For example, the hardware for processing the data may include an arithmetic and logic unit (ALU), a floating point unit (FPU), a field programmable gate array (FPGA), a central processing unit (CPU), and/or an application processor (AP). The processor 110 may have a structure of a single-core processor or may have a structure of a multi-core processor including a dual core, a quad core, a hexa core, or an octa core.

The mobility control apparatus 100 may include the speaker 120. For example, the speaker 120 may convert an electrical signal to a sound. For example, the speaker 120 may cause vibration of a diaphragm included in the speaker 120, based on that the electrical signal is input, thus converting the electrical signal into a sound.

In some implementations, the speaker 120 may include at least one of a main speaker or a sub-speaker for outputting a sound independently of the main speaker, or any combination thereof.

The mobility control apparatus 100 may include the display 130. In some implementations, the display 130 may provide a user with visualized information. For example, the display 130 may be controlled by at least one of the processor 110 or a graphic processing unit (GPU), or any combination thereof to output the visualized information to the user.

For example, the display 130 may include at least one of a flat panel display (FPD) or an electronic paper, or any combination thereof. The FPD may include at least one of a liquid crystal display (LCD), a plasma display panel (PDP), a digital mirror device (DMD), one or more light emitting diodes (LEDs), a micro-LED, or a flexible display, or any combination thereof. The LED may include an organic LED (OLED). However, an implementation of the present disclosure is not limited to those described above.

For example, the display 130 may include at least one of a first display or a second display, or any combination thereof. For example, the display 130 may include at least one of a main display associated with the main speaker or a sub-display associated with the sub-speaker, or any combination thereof.

In some implementations, the processor 110 may identify whether at least one of media content or an application for playing the media content, or any combination thereof is being executed.

In some implementations, the processor 110 may receive a request signal for requesting an output of a sound via at least one of the main speaker or the sub-speaker, or any combination thereof.

In some implementations, the processor 110 may identify at least one speaker to output a target sound between the main speaker and the sub-speaker, based on at least one of a priority of the sound associated with the request signal, a sound which is being output from the main speaker, or a sound which is being output from the sub-speaker, or any combination thereof.

In some implementations, the processor 110 may output the target sound via the identified at least one speaker, based on identifying the at least one speaker to output the target sound.

In some implementations, the processor 110 may identify a speaker to output the target sound, based on execution of the application. The processor 110 may output a screen provided by the application, together with outputting the target sound using the sub-speaker, based on identifying outputting the target sound using the sub-speaker between the main speaker and the sub-speaker.

In some implementations, the processor 110 may identify a speaker to output the target sound, based on the execution of the application, and may identify the display 130 associated with the main speaker, based on identifying outputting the target sound using the main speaker between the main speaker and the sub-speaker.

In some implementations, the processor 110 may identify the speaker to output the target sound, based on the execution of the application, and may identify the display 130 coupled with the main speaker, based on identifying outputting the target sound using the main speaker between the main speaker and the sub-speaker. For example, that A and B are coupled with each other may include that A and B are directly and/or indirectly coupled with each other. For example, that A and B are coupled with each other may include that A and B are electrically and/or indirectly coupled with each other.

Hereinafter, the display associated with the speaker may include the display coupled with the speaker.

For example, the main speaker associated with the display 130 may output the target sound associated with at least one of a screen output from the display 130 or a screen provided by the application provided via the display 130, or any combination thereof. For example, associating in the present disclosure may refer to a state in which it is able to output a sound associated with the screen provided via the display 130.

In some implementations, the processor 110 may identify that the display associated with the main speaker is identified as the second display different from the first display which is outputting the screen provided by the application or that it is requested to output the target sound with the highest priority compared to sounds which are being output.

In some implementations, the processor 110 may provide target media content by means of the application, based on that the display associated with the main speaker is identified as the second display different from the first display which is outputting the screen provided by the application or that it is requested to output the target sound with the highest priority compared to the sounds which are being output.

In some implementations, the processor 110 may fail to request the main speaker to be associated with a display different from the second display, based on that the display associated with the main speaker is identified as the second display different from the first display which is outputting the screen provided by the application or that it is requested to output the target sound with the highest priority compared to the sounds which are being output.

For example, the processor 110 may provide guidance indicating that the main speaker and the second display are associated with each other, based on that the display associated with the main speaker is identified as the second display different from the first display which is outputting the screen provided by the application or that it is requested to output the target sound with the highest priority compared to the sounds which are being output.

In some implementations, the processor 110 may identify that the main speaker and the second display are associated each with or that the target media content is not output via the second display, in the state in which it is requested to output the target sound with the highest priority compared to the sounds which are being output.

For example, the target sound with the highest priority compared to the sounds which are being output may include at least one of an emergency call, an SOS call, a hands-free call, or front seat speed recognition, or any combination thereof.

For example, a sound different from the target sound with the highest priority compared to the sounds which are being output may include at least one of a sound provided by general media content, a navigation guidance sound, a radio sound, or a music sound using a universal serial bus (USB), or any combination thereof.

In some implementations, the processor 110 may provide target media content by means of the application, based on that the main speaker and the second display are associated with each other or that the target media content is not output via the second display, in the state in which it is requested to output the target sound with the highest priority compared to the sounds which are being output.

In some implementations, the processor 110 may request the main speaker to be associated with the display different from the second display, based on that the main speaker and the second display are associated with each other or that the target media content is not output via the second display, in the state in which it is requested to output the target sound with the highest priority compared to the sounds which are being output.

In some implementations, the processor 110 may output the target sound, in response to that the output of the target media content is ended, based on that the main speaker and the second display are associated with each other or that the target media content is not output via the second display, in the state in which it is requested to output the target sound with the highest priority compared to the sounds which are being output.

In some implementations, the processor 110 may identify that the main speaker is associated with the second display, in the state in which it is requested to output the target sound with the highest priority compared to the sounds which are being output.

In some implementations, the processor 110 may provide the target media content by means of the application, based on that the main speaker is associated with the second display, in the state in which it is requested to output the target sound with the highest priority compared to the sounds which are being output.

In some implementations, the processor 110 may request the main speaker to be associated with the display different from the second display, based on identifying that the main speaker is associated with the second display, in the state in which it is requested to output the target sound with the highest priority compared to the sounds which are being output.

In some implementations, the processor 110 may output the target sound via the main speaker, based on identifying that the main speaker and the second display are associated with each other, in the state in which it is requested to output the target sound with the highest priority compared to the sounds which are being output.

In some implementations, the processor 110 may receive a setting signal for being set to a mode for outputting the target sound using at least one of the main speaker or the sub-speaker, or any combination thereof, in the state in which at least one of the media content or the application for playing the media content, or any combination thereof is being executed. For example, the mode may include a state set to output the target sound via selected at least one speaker, based on selecting the at least one speaker to output the target sound in the mobility.

For example, the processor 110 may identify a speaker corresponding to the setting signal. The processor 110 may identify whether the target sound is being output via the speaker corresponding to the setting signal. The processor 110 may bypass the setting signal, based on that the target sound is being output via the speaker corresponding to the setting signal.

For example, the processor 110 may change to the mode for outputting the target sound via the speaker corresponding to the setting signal, based on that the target sound is being output via a speaker different from the speaker corresponding to the speaker.

For example, the processor 110 may output the target sound via the speaker different from the speaker corresponding to the setting signal, based on identifying that it is impossible to output the target sound via the speaker corresponding to the speaker.

In some implementations, the processor 110 may guide the user to output the target sound via at least one of the main speaker or the sub-speaker, or any combination thereof, based on at least one of the main display or the sub-display, or any combination thereof.

As described above, the mobility control apparatus 100 may select the speaker to output the sound, thus reinforcing a user experience. Furthermore, the mobility control apparatus 100 may select the speaker to output the sound, thus increasing convenience of the user.

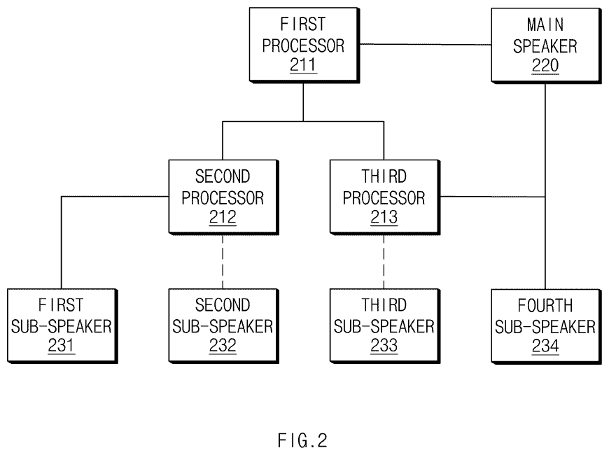

FIG. 2 is a diagram illustrating an example of a mobility control apparatus.

Referring to FIG. 2, the mobility control apparatus (e.g., a mobility control apparatus 100 of FIG. 1) may include a plurality of processors. For example, the plurality of processors may include a first processor 211, a second processor 212, and/or a third processor 213. The first processor 211, the second processor 212, and/or the third processor 213 may be referred to a processor 110 of FIG. 1.

The mobility control apparatus may include a plurality of speakers. For example, the plurality of speakers may include a main speaker 220, a first sub-speaker 231, a second sub-speaker 232, a third sub-speaker 233, and/or a fourth sub-speaker 234. For example, the main speaker 220, the first sub-speaker 231, the second sub-speaker 232, the third sub-speaker 233, and/or the fourth sub-speaker 234 may be referred to a speaker 120 of FIG. 1.

For example, the first processor 211 may control hardware components included in a front seat of the mobility and software components. For example, the second processor 212 and/or the third processor 213 may control hardware components included in a rear seat of the mobility and software components.

For example, the second processor 212 may control a left display among displays arranged on the rear seat of the mobility. For example, the third processor 213 may control a right display among the displays arranged on the rear seat of the mobility. However, an implementation of the present disclosure is not limited to those described above.

For example, the main speaker 220 may include a mobility amplifier (AMP). For example, the main speaker 220 may be referred to as a public speaker.

For example, the first sub-speaker 231, the second sub-speaker 232, the third sub-speaker 233, and/or the fourth sub-speaker 234 may include a head-rest speaker and/or a Bluetooth speaker. For example, the head-rest speaker may be disposed around the position of the head of a passenger on the rear seat of the mobility. For example, the Bluetooth speaker may wirelessly establish a communication link with the mobility, via a communication circuit included in the mobility.

As described above, the mobility control apparatus may control various speakers included in the mobility.

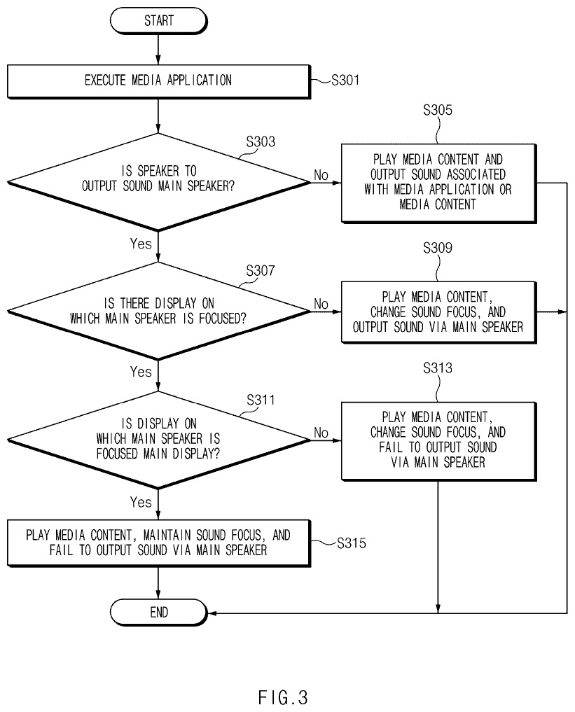

FIG. 3 illustrates an example of a flowchart associated with a mobility control method.

Hereinafter, it is assumed that a mobility control apparatus 100 of FIG. 1 performs a process of FIG. 3. Furthermore, in a description of FIG. 3, an operation described as being performed by an apparatus may be understood as being controlled by a processor 110 of the mobility control apparatus 100.

At least one of the operations of FIG. 3 may be performed by the mobility control apparatus 100 of FIG. 1. At least one of the operations of FIG. 3 may be controlled by the processor 110 of FIG. 1. The respective operations of FIG. 3 may be sequentially performed, but are not necessarily sequentially performed. For example, an order of the respective operations may be changed, and at least two operations may be performed in parallel.

Referring to FIG. 3, in S301, the mobility control method may include executing a media application.

In S303, the mobility control method may include identifying whether a speaker to output a sound is a main speaker.

For example, the mobility control method may include identifying whether the speaker to output the sound is at least one of a public AMP, a Bluetooth headset, or a head-rest speaker, or any combination thereof.

For example, the main speaker may include a public AMP. For example, a sub-speaker different from the main speaker may include at least one of a Bluetooth headset or a head-rest speaker, or any combination thereof.

For example, the main speaker may be referred to as a public sound output device. For example, the sub-speaker may be referred to as an independent sound output device.

If the speaker to output the sound is not the main speaker (No in S303), in S305, the mobility control method may include playing media content and outputting a sound associated with the media application or the media content.

For example, the case in which the speaker to output the sound is not the main speaker may include a case for outputting the sound, via the independent sound output device.

For example, the sound associated with the media content may include a sound provided from the media content.

If the speaker to output the sound is the main speaker (Yes in S303), in S307, the mobility control method may include identifying whether there is a display on which the main speaker is focused.

For example, the mobility control method may include identifying whether the public sound output device occupies a sound focus.

For example, occupying the sound focus may include being ready to output a sound associated with media content provided from a specific display.

If there is no the display on which the main speaker is focused (No in S307), in S309, the mobility control method may include playing the media content, changing the sound focus, and outputting the sound via the main speaker.

For example, if there is no display which occupies the sound focus of the public sound output device, the mobility control method may include outputting the media content, requesting the sound focus, and outputting the sound via the public sound output device.

If there is the display on which the main speaker is focused (Yes in S307), in S311, the mobility control method may include identifying whether the display on which the main speaker is focused is a main display.

If the display on which the main speaker is focused is not the main display (No in S311), in S313, the mobility control method may include playing the media content, changing the sound focus, and failing to output the sound via the main speaker.

For example, the mobility control method may include playing the media content, changing the sound focus, and failing to output the sound, if the sound is currently pending on the display in a front seat priority mode or if there is no display on which the sound is pending in the front seat priority mode. However, the mobility control method may include outputting the sound, if the pending of the sound is released.

If the display on which the main speaker is focused is the main display (Yes in S311), in S315, the mobility control method can include playing the media content, maintaining the sound focus, and failing to output the sound via the main speaker.

For example, the mobility control method may include outputting the media content, failing to change the sound focus, failing to output the sound, and outputting a pop-up message, if the sound focus is occupied by another display or if the sound focus is pending on the other display in the front seat priority mode. For example, the pop-up message may include a message indicating that the other display is using the main speaker and for providing guidance for directly changing a speaker setting.

As described above, the mobility control method may be to select the speaker to output the sound, if the media application is executed, and output the sound via the selected speaker, thus reinforcing a user experience.

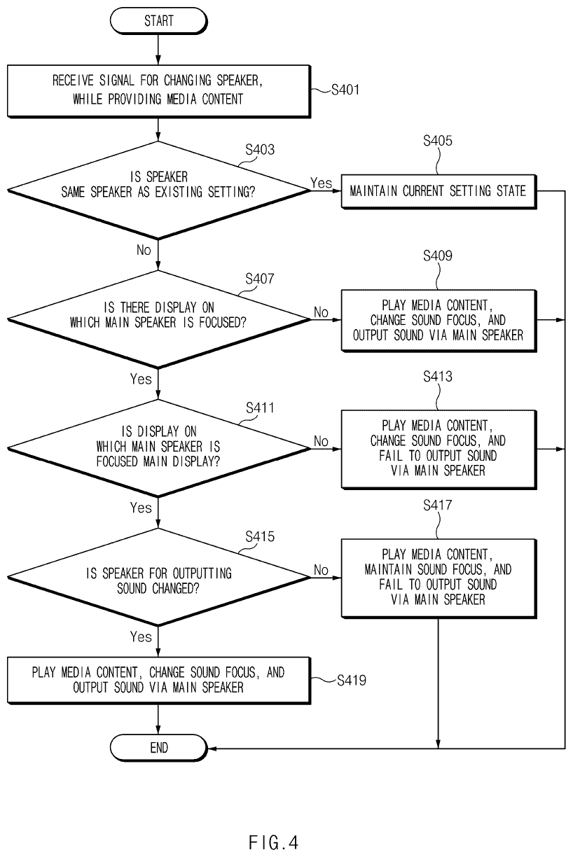

FIG. 4 illustrates an example of a flowchart associated with a mobility control method.

Hereinafter, it is assumed that a mobility control apparatus 100 of FIG. 1 performs a process of FIG. 4. Furthermore, in a description of FIG. 4, an operation described as being performed by an apparatus may be understood as being controlled by a processor 110 of the mobility control apparatus 100.

At least one of the operations of FIG. 4 may be performed by the mobility control apparatus 100 of FIG. 1. At least one of the operations of FIG. 4 may be controlled by the processor 110 of FIG. 1. The respective operations of FIG. 4 may be sequentially performed, but are not necessarily sequentially performed. For example, an order of the respective operations may be changed, and at least two operations may be performed in parallel.

Referring to FIG. 4, in S401, the mobility control may include receiving a signal for changing a speaker, while providing media content. For example, the mobility control method may include receiving the signal for changing the speaker for outputting a sound provided by the media content, while outputting the media content.

In S403, the mobility control method may include identifying whether the speaker is the same speaker as an existing setting. For example, the mobility control method may include identifying the speaker for outputting the sound and a speaker corresponding to the signal for changing the speaker are identical to each other.

For example, the mobility control method may include identifying the speaker for currently outputting the sound is the same speaker as the speaker corresponding to the change signal.

If the speaker is the same speaker as the existing setting (Yes in S403), in S405, the mobility control method may include maintaining the current setting state.

If the speaker is not the same speaker as the existing setting (No in S403), in S407, the mobility control method may include identifying whether there is a display on which a main speaker is focused.

For example, if the speaker is not the same speaker as the existing setting, the mobility control method may include changing the speaker for outputting the sound to a corresponding speaker.

If there is no the display on which the main speaker is focused (No in S407), in S409, the mobility control method may include playing media content, changing a sound focus, and outputting the sound via the main speaker.

For example, if there is no display which occupies the sound focus of the public sound output device (e.g., the main speaker), the mobility control method may include outputting the media content, changing the sound focus, and outputting the sound.

If there is the display on which the main speaker is focused (Yes in S407), in S411, the mobility control method may include identifying whether the display on which the main speaker is focused is a main display.

If the display on which the main speaker is focused is not the main display (No in S411), in S413, the mobility control method may include playing the media content, changing the sound focus, and failing to output the sound via the main speaker.

For example, if there is no display on which the public sound output device is pending in a front seat priority mode, the mobility control method may include playing the media content, changing the sound focus, and failing to output the sound.

If the display on which the main speaker is focused is the main display (Yes in S411), in S415, the mobility control method may include identifying whether the speaker for outputting the sound is changed.

For example, if the display on which the main speaker is focused is the main display, the mobility control method may include providing a screen for selecting whether to change the speaker for outputting the sound, via the main display. For example, the mobility control method may include receiving a signal for changing the speaker, via the screen. The mobility control method may include receiving one of the signal for changing the speaker for outputting the sound or a signal for maintaining the speaker for outputting the sound. The mobility control method may include executing a function corresponding to the received signal, based on receiving the one of the signal for changing the speaker for outputting the sound or the signal for maintaining the speaker for outputting the sound.

If the speaker for outputting the sound is not changed (No in S415), in S417, the mobility control method may include playing the media content, maintaining the sound focus, and failing to output the sound via the main speaker.

For example, the mobility control method may include providing a pop-up notification, if another display occupies the public sound output device or if the focus is pending on the other display in the front seat priority mode.

For example, the pop-up notification may include a message indicating that the other display is using the speaker. For example, the pop-up notification may include a message for ending the speaker which is in use in the other display and using the speaker in a display which is being controlled.

For example, the mobility control method may include playing the media content, maintaining the sound focus, and failing to output the sound via the main speaker, based on identifying that the speaker is not changed based on the pop-up notification.

If the speaker for outputting the sound is changed (Yes in S415), in S419, the mobility control method may include playing the media content, changing the sound focus, and outputting the sound via the main speaker.

For example, the mobility control method may include receiving a signal for changing the speaker. For example, the mobility control method may include receiving the signal for changing the speaker for outputting the sound, based on the pop-up notification.

For example, the mobility control method may include playing the media content, changing the sound focus, and outputting the sound via the main speaker, based on identifying that the speaker is changed based on the pop-up notification.

As described above, the mobility control method may be to output the sound via the selected speaker, in response to receiving the signal for changing the speaker while providing the media content, thus reinforcing a user experience.

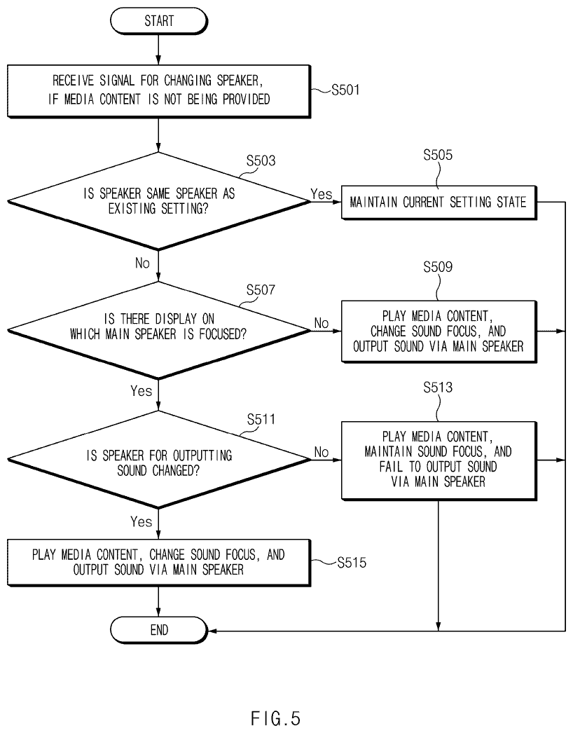

FIG. 5 illustrates an example of a flowchart associated with a mobility control method.

Hereinafter, it is assumed that a mobility control apparatus 100 of FIG. 1 performs a process of FIG. 5. Furthermore, in a description of FIG. 5, an operation described as being performed by an apparatus may be understood as being controlled by a processor 110 of the mobility control apparatus 100.

At least one of the operations of FIG. 5 may be performed by the mobility control apparatus 100 of FIG. 1. At least one of the operations of FIG. 5 may be controlled by the processor 110 of FIG. 1. The respective operations of FIG. 5 may be sequentially performed, but are not necessarily sequentially performed. For example, an order of the respective operations may be changed, and at least two operations may be performed in parallel.

Referring to FIG. 5, in S501, the mobility control method may include receiving a signal for changing a speaker, if media content is not being provided.

For example, the mobility control method may include receiving the signal for changing the speaker for outputting a sound, while the media content is not output.

In S503, the mobility control method may include identifying whether the speaker is the same speaker as an existing setting. For example, S503 may be referred to S403 of FIG. 4.

If the speaker is the same speaker as the existing setting (Yes in S503), in S505, the mobility control method may include maintaining a current setting state. For example, S505 may be referred to S405 of FIG. 4.

If the speaker is not the same speaker as the existing setting (No in S503), in S507, the mobility control method may include identifying whether there is a display on which a main speaker is focused. For example, S507 may be referred to S407 of FIG. 4.

If there is no the display on which the main speaker is focused (No in S507), in S509, the mobility control method may include playing media content, changing a sound focus, and outputting the sound via the main speaker. For example, S509 may be referred to S409 of FIG. 4.

If there is the display on which the main speaker is focused (Yes in S507), in S511, the mobility control method may include identifying whether the speaker for outputting the sound is changed. For example, S511 may be referred to S415 of FIG. 4.

If the speaker for outputting the sound is not changed (No in S511), in S513, the mobility control method may include playing the media content, maintaining the sound focus, and failing to output the sound via the main speaker. For example, S513 may be referred to S417 of FIG. 4.

If the speaker for outputting the sound is changed (Yes in S511), in S515, the mobility control method may include playing the media content, changing the sound focus, and outputting the sound via the main speaker. S515 may be referred to S419 of FIG. 4.

As described above, the mobility control method may be to output the sound via the selected speaker, in response to receiving the signal for changing the speaker while not providing the media content, thus reinforcing a user experience.

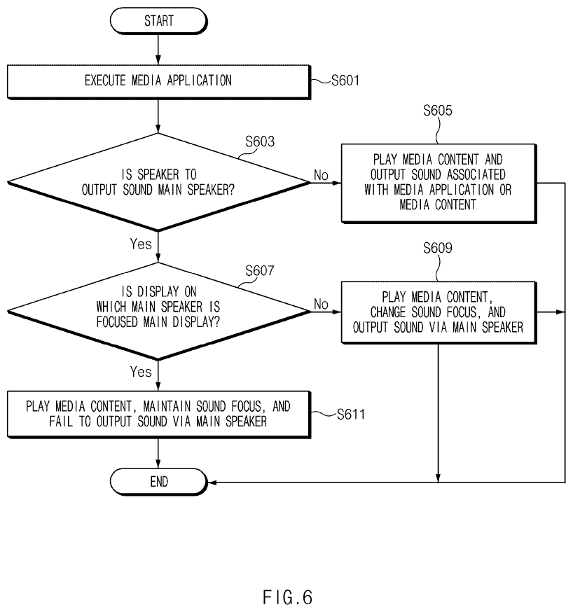

FIG. 6 illustrates an example of a flowchart associated with a mobility control method.

Hereinafter, it is assumed that a mobility control apparatus 100 of FIG. 1 performs a process of FIG. 6. Furthermore, in a description of FIG. 6, an operation described as being performed by an apparatus may be understood as being controlled by a processor 110 of the mobility control apparatus 100.

At least one of the operations of FIG. 6 may be performed by the mobility control apparatus 100 of FIG. 1. At least one of the operations of FIG. 6 may be controlled by the processor 110 of FIG. 1. The respective operations of FIG. 6 may be sequentially performed, but are not necessarily sequentially performed. For example, an order of the respective operations may be changed, and at least two operations may be performed in parallel.

Referring to FIG. 6, in S601, the mobility control method may include executing a media application.

In S603, the mobility control method may include identifying whether a speaker to output a sound is a main speaker.

If the speaker to output the sound is not the main speaker (No in S603), in S605, the mobility control method may include playing media content and outputting a sound associated with the media application or the media content.

For example, the mobility control method may include outputting a sound using an independent sound output device (e.g., a Bluetooth headset and/or a head-rest speaker) and outputting the media content.

If the speaker to output the sound is the main speaker (Yes in S603), in S607, the mobility control method may include identifying whether a display on which the main speaker is focused is a main display. For example, S607 may be referred to S411 of FIG. 4.

If the display on which the main speaker is focused is not the main display (No in S607), in S609, the mobility control method may include playing the media content, changing a sound focus, and outputting the sound via the main speaker.

For example, if there is no display which occupies the sound focus of a public sound output device, the mobility control method may include playing the media content, changing the sound focus, and outputting the sound via the main speaker.

If the display on which the main speaker is focused is the main display (Yes in S607), in S611, the mobility control method may include playing the media content, maintaining the sound focus, and failing to output the sound via the main speaker.

For example, if the main speaker is currently pending on the display in a front seat priority mode, there is no display on which the main speaker is pending in the front seat priority mode, or the focus of the main speaker is pending on another display in the front seat priority mode, the mobility control method may include outputting the media content, changing the sound focus, and failing to output the sound.

As described above, the mobility control method may be to output the sound via the selected speaker, in response to the execution of the media application, thus reinforcing a user experience.

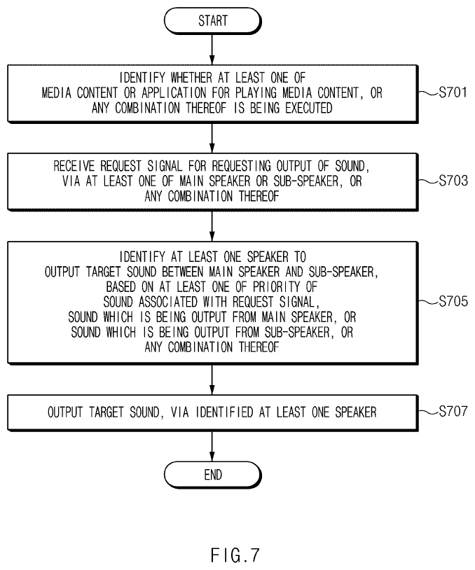

FIG. 7 illustrates an example of a flowchart associated with a mobility control method.

Hereinafter, it is assumed that a mobility control apparatus 100 of FIG. 1 performs a process of FIG. 7. Furthermore, in a description of FIG. 7, an operation described as being performed by an apparatus may be understood as being controlled by a processor 110 of the mobility control apparatus 100.

At least one of the operations of FIG. 7 may be performed by the mobility control apparatus 100 of FIG. 1. At least one of the operations of FIG. 7 may be controlled by the processor 110 of FIG. 1. The respective operations of FIG. 7 may be sequentially performed, but are not necessarily sequentially performed. For example, an order of the respective operations may be changed, and at least two operations may be performed in parallel.

Referring to FIG. 7, in S701, the mobility control method may include identifying whether at least one of media content or an application for playing the media content, or any combination thereof is being executed.

In S703 the mobility control may include receiving a request signal for requesting an output of a sound, via at least one of a main speaker or a sub-speaker, or any combination thereof.

In S705, the mobility control method may include identifying at least one speaker to output a target sound between the main speaker and the sub-speaker, based on at least one of a priority of the sound associated with the request signal, a sound which is being output from the main speaker, or a sound which is being output from the sub-speaker, or any combination thereof.

In S707, the mobility control method may include outputting the target sound, via the identified at least one speaker.

The mobility control method may include identifying a speaker to output the target sound, based on execution of the application. The mobility control method may include outputting a screen provided by the application, together with outputting the target sound using the sub-speaker, based on identifying outputting the target sound using the sub-speaker between the main speaker and the sub-speaker. The mobility control method may include identifying a display associated with the main speaker, based on identifying outputting the target sound using the main speaker between the main speaker and the sub-speaker.

The mobility control method may include, based on that the display associated with the main speaker is identified as a second display different from a first display which is outputting a screen provided by the application or that it is requested to output a target sound with the highest priority compared to sounds which are being output, providing target media content by means of the application, failing to request the main speaker to be associated with a display different from the second display, and providing guidance indicating that the main speaker and the second display are associated with each other, via at least one of the first display or the second display.

The mobility control method may include, based on that the main speaker and the second display are associated with each other or that the target media content is not output via the second display, in the state in which it is requested to output the target sound with the highest priority compared to the sounds which are being output, providing the target media content by means of the application, requesting the main speaker to be associated with the display different from the second display, and outputting the target sound, in response to that the output of the target media content is ended.

The mobility control method may include, based on identifying that the main speaker is associated with the second display, in the state in which it is requested to output the target sound with the highest priority compared to the sounds which are being output, providing the target media content by means of the application, requesting the main speaker to be associated with the display different from the second display, and outputting the target sound via the main speaker.

The mobility control method may include receiving a setting signal for being set to a mode for outputting the target sound using at least one of the main speaker or the sub-speaker, or any combination thereof, in the state in which at least one of the media content or the application for playing the media content, or any combination thereof is being executed. For example, the mode may include a state set to output the target sound via selected at least one speaker, based on selecting the at least one speaker to output the target sound in a mobility. The mobility control method may include identifying whether the target sound is being output via a speaker corresponding to the setting signal. The mobility control method may include bypassing the setting signal, based on that the target sound is being output via the speaker corresponding to the setting signal.

The mobility control method may include being set to the mode for outputting the target sound via the speaker corresponding to the setting signal, based on that the target sound is being output via a speaker different from the speaker corresponding to the speaker.

The mobility control method may include outputting the target sound via the speaker different from the speaker corresponding to the setting signal, based on identifying that it is impossible to output the target sound via the speaker corresponding to the speaker.

The mobility control method may include guiding a user to output the target sound via at least one of the main speaker or the sub-speaker, or any combination thereof, based on at least one of the main display or the sub-display, or any combination thereof.

As described above, the mobility control method may be to select the speaker to output the sound, thus reinforcing a user experience. Furthermore, the mobility control method may be to select the speaker to output the sound, thus increasing convenience of the user.

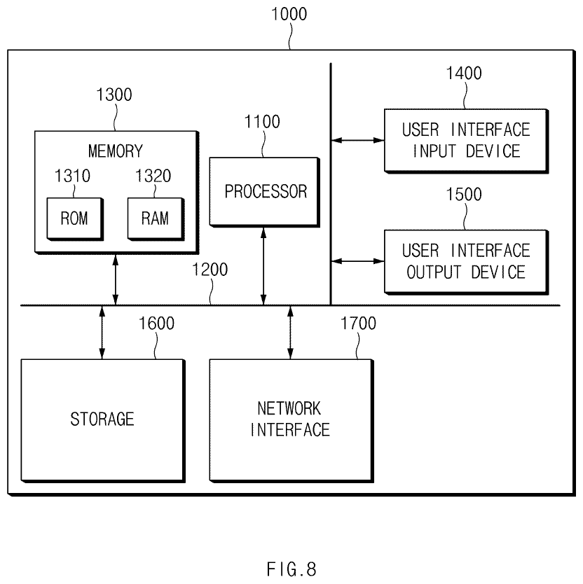

FIG. 8 illustrates a computing system associated with a mobility control apparatus or a mobility control method.

Referring to FIG. 8, a computing system 1000 may include at least one processor 1100, a memory 1300, a user interface input device 1400, a user interface output device 1500, a storage 1600, and a network interface 1700, which are coupled with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (RCM) 1310 and a random access memory (RAM) 1320.

Accordingly, the operations of the method or algorithm described in connection with the implementations disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present technology may control a speaker included in the mobility.

Furthermore, the present technology may output a sound using at least one of speakers included in the mobility depending on a situation.

Furthermore, the present technology may determine a speaker to output a sound depending on a priority of the sound.

In addition, various effects ascertained directly or indirectly through the present disclosure may be provided.

What is claimed is:

1. A mobility control apparatus, comprising:
a main speaker;
a sub-speaker configured to output a sound independently from the main speaker;
a memory storing instructions; and
a processor configured to execute the instructions to perform operations comprising:
identifying whether at least one of media content or an application for playing the media content is being executed;
receiving a request signal for requesting an output of a sound via at least one of the main speaker or the sub-speaker;
identifying, based on at least one of a priority of the sound associated with the request signal, a sound from the main speaker, or a sound from the sub-speaker, at least one speaker, among the main speaker and the sub-speaker, to output a target sound; and
outputting, via the identified at least one speaker, the target sound.

2. The mobility control apparatus of claim 1, wherein the operations comprise:
identifying, based on the application being executed, a speaker, among the main speaker and the sub-speaker, to output the target sound; and
outputting, based on the sub-speaker being identified to output the target sound, the target sound via the sub-speaker with a screen provided by the application.

3. The mobility control apparatus of claim 1, wherein the operations comprise:
identifying, based on the application being executed, a speaker, among the main speaker and the sub-speaker, to output the target sound; and
identifying, based on the main speaker being identified to output the target sound, a display coupled with the main speaker.

4. The mobility control apparatus of claim 3, wherein the operations comprise:
based on that (i) the display coupled with the main speaker is identified as a second display different from a first display outputting a screen provided by the application or (ii) it is requested to output the target sound with a highest priority compared to sounds which are being output:
providing target media content through the application;
preventing the main speaker to be associated with a display different from the second display; and
providing guidance indicating that the main speaker and the second display are coupled with each other, via at least one of the first display or the second display.

5. The mobility control apparatus of claim 3, wherein the operations comprise:
based on (i) the target sound with a highest priority compared to output sounds being requested and (ii) the main speaker and a second display being associated with each other or target media content not being output via the second display:
providing the target media content through the application;
requesting the main speaker to be associated with a display different from the second display; and
outputting, based on completion of the target media content, the target sound.

6. The mobility control apparatus of claim 3, wherein the operations comprise:
based on (i) the target sound with a highest priority compared to output sounds being requested and (ii) the main speaker and a second display being identified as being coupled with each other:
providing target media content through the application;
requesting the main speaker to be associated with a display different from the second display; and
outputting the target sound via the main speaker.

7. The mobility control apparatus of claim 1, wherein the operations comprise:
receiving, based on at least one of the media content or the application for playing the media content being executed, a setting signal configured to set a mode for outputting the target sound via at least one of the main speaker or the sub-speaker;
determining whether the target sound is being output via a speaker corresponding to the setting signal; and
bypassing the setting signal, based on a determination that the target sound is being output via the speaker corresponding to the setting signal, and
wherein, based on the at least one speaker being selected to output the target sound in a mobility, the mode includes a state set to output the target sound via the selected at least one speaker.

8. The mobility control apparatus of claim 7, wherein the operations comprise:
changing, based on the target sound is being output via a speaker different from the speaker corresponding to the setting signal, to the mode for outputting the target sound via the speaker corresponding to the setting signal.

9. The mobility control apparatus of claim 7, wherein the operations comprise:
outputting, based on a determination that the target sound cannot be output via the speaker corresponding to the setting signal, the target sound via a speaker different from the speaker corresponding to the setting signal.

10. The mobility control apparatus of claim 1, further comprising:
a main display coupled with the main speaker; and
a sub-display coupled with the sub-speaker,
wherein the operations further comprise:
outputting, via at least one of the main display or the sub-display, guidance to a user to output the target sound via at least one of the main speaker or the sub-speaker.

11. A mobility control method, comprising:
identifying, by a processor, whether at least one of media content or an application for playing the media content is being executed;
receiving, at the processor, a request signal for requesting an output of a sound via at least one of a main speaker or a sub-speaker;
identifying, based on at least one of a priority of the sound associated with the request signal, a sound from the main speaker, or a sound from the sub-speaker, at least one speaker, among the main speaker and the sub-speaker, to output a target sound, by the processor; and
outputting, via the identified at least one speaker, the target sound.

12. The mobility control method of claim 11, further comprising:
identifying, based on the application being executed, a speaker, among the main speaker and the sub-speaker, to output the target sound; and
outputting, based on the sub-speaker being identified to output the target sound, the target sound via the sub-speaker with a screen provided by the application.

13. The mobility control method of claim 11, further comprising:
identifying, based on the application being executed, a speaker, among the main speaker and the sub-speaker, to output the target sound; and
identifying, based on the main speaker being identified to output the target sound, a display coupled with the main speaker.

14. The mobility control method of claim 13, further comprising:
based on that (i) the display coupled with the main speaker is identified as a second display different from a first display outputting a screen provided by the application or (ii) it is requested to output the target sound with a highest priority compared to sounds which are being output:
providing target media content through the application;
preventing the main speaker to be associated with a display different from the second display; and
providing guidance indicating that the main speaker and the second display are coupled with each other, via at least one of the first display or the second display.

15. The mobility control method of claim 13, further comprising:
based on (i) the target sound with a highest priority compared to output sounds being requested and (ii) the main speaker and a second display being associated with each other or target media content not being output via the second display:
providing the target media content through the application;
requesting the main speaker to be associated with a display different from the second display; and
outputting, based on completion of the target media content, the target sound.

16. The mobility control method of claim 13, further comprising:
based on (i) the target sound with a highest priority compared to output sounds being requested and (ii) the main speaker and a second display being identified as being coupled with each other:
providing target media content through the application;
requesting the main speaker to be associated with a display different from the second display; and
outputting the target sound via the main speaker.

17. The mobility control method of claim 11, further comprising:
receiving, based on at least one of the media content or the application for playing the media content being executed, a setting signal configured to set a mode for outputting the target sound via at least one of the main speaker or the sub-speaker;
determining whether the target sound is being output via a speaker corresponding to the setting signal; and
bypassing the setting signal, based on a determination that the target sound is being output via the speaker corresponding to the setting signal,
wherein, based on the at least one speaker being selected to output the target sound in a mobility, the mode includes a state set to output the target sound via the selected at least one speaker.

18. The mobility control method of claim 17, further comprising:
changing, based on the target sound is being output via a speaker different from the speaker corresponding to the setting signal, to the mode for outputting the target sound via the speaker corresponding to the setting signal.

19. The mobility control method of claim 17, further comprising:
outputting, based on a determination that the target sound cannot be output via the speaker corresponding to the setting signal, the target sound via a speaker different from the speaker corresponding to the setting signal.

20. The mobility control method of claim 11, further comprising:
outputting, via at least one of a main display or a sub-display, guidance to a user to output the target sound via at least one of the main speaker or the sub-speaker.
